(19) United States
(12) Patent Application Publication
(10) Pub. No.: US 2026/0220741 A1
(43) Pub. Date: Jul. 30, 2026

(54) Semantic-Based Image Signal Processing

(71) Applicant: Google LLC, Mountain View, CA (US)

(72) Inventors: Jun Nishimura, Cupertino, CA (US); Liang-Chun Lin, Santa Clara, CA (US)

(21) Appl. No.: 19/148,298

(22) PCT Filed: May 31, 2023
(86) PCT No.: PCT/US2023/024031

§ 371 Date: Jul. 15, 2025

(51) Int. Cl. G06T 5/20; G06T 5/60

(52) U.S. Cl. CPC G06T 5/20; G06T 5/60; G06T 2207/20028

(57) ABSTRACT

A method includes obtaining an image and, based thereon, generating a bilateral grid representing transform coefficients configured to map pixel values of the input image to filter guide values. Each respective transform coefficient may be based on a corresponding class of an image feature represented by a corresponding pixel of the image. The corresponding class may be one of multiple image feature classes represented by the image. The method may also include generating, based on the bilateral grid, a transform coefficient corresponding to a selected pixel of the image, and applying the transform coefficient to a pixel value of the selected pixel to generate a filter guide value. The method may further include generating an output image by applying an operator to the pixel value based on the filter guide value. A parameter of the operator may differ across the multiple classes as a function of the filter guide value.

### BACKGROUND

An image filter may be configured to generate an output image by modifying pixel values of an input image. The image filter may include an operator that, when applied to the pixel values of the input image, generates corresponding pixel values in the output image. The operator may be, for example, a kernel, vector, matrix, and/or other function that transforms the pixel values of the input image in a desirable manner (e.g., blurring, sharpening, adjusting color, etc.). In some cases, the operator may be fixed, such that substantially the same operator is applied throughout the entirety of the input image.

### SUMMARY

An image filter may be configured to generate an output image by applying a corresponding operator to an input image. A parameter of the operator may vary as a function of semantic information associated with pixels of the input image, and the image filter may thus be considered semantically variable and/or semantically aware. The semantic information may be represented using a bilateral grid that has a lower resolution than the input image, and thus provides a compressed representation of the semantic information. The semantic information may be expressed using transform coefficients configured to map pixel values of the input image to corresponding filter guide values that control the semantic variability of the image filter. The bilateral grid may allow for upsampling of the transform coefficients, thus allowing the filter guide values to be determined and applied at, for example, the resolution of the input image, among other possible resolutions. Additionally, the bilateral grid may allow the transform coefficients for a given pixel to be determined independently of determining the transform coefficients for other pixels, thus allowing the image filter to operate on as little as one pixel of the input image, and thereby avoiding operating with respect to pixels of the input image that are not selected for filtering.

In a first example embodiment, a method includes obtaining an input image having a first spatial resolution, and generating, based on the input image and by a bilateral grid model that includes a machine learning (ML) model, a bilateral grid representing, at a second spatial resolution that is smaller than the first spatial resolution, a plurality of transform coefficients configured to map pixel values of the input image to filter guide values. Each respective transform coefficient of the plurality of transform coefficients may be based on a corresponding class of an image feature represented by a corresponding pixel of the input image. The corresponding class may be one of a plurality of classes of image features represented by the input image. The method may also include generating, based on the bilateral grid, one or more transform coefficients corresponding to a selected pixel of the input image, and applying the one or more transform coefficients to a pixel value of the selected pixel to generate a filter guide value for the selected pixel at the first spatial resolution. The method may further include generating an output image by applying a corresponding operator to the pixel value of the selected pixel based on the filter guide value for the selected pixel. At least one parameter of the corresponding operator may differ across the plurality of classes as a function of the filter guide value.

In a second example embodiments, a system may include image reception circuitry configured to obtain an input image having a first spatial resolution, and a bilateral grid model that includes an ML model and is configured to generate, based on the input image, a bilateral grid representing, at a second spatial resolution that is smaller than the first spatial resolution, a plurality of transform coefficients configured to map pixel values of the input image to filter guide values. Each respective transform coefficient of the plurality of transform coefficients may be based on a corresponding class of an image feature represented by a corresponding pixel of the input image. The corresponding class may be one of a plurality of classes of image features represented by the input image The system may also include a grid slicing circuitry configured to generate, based on the bilateral grid, one or more transform coefficients corresponding to a selected pixel of the input image, and a transform circuitry configured to apply the one or more transform coefficients to a pixel value of the selected pixel to generate a filter guide value for the selected pixel at the first spatial resolution. The system may further include image filter circuitry configured to generate an output image by applying a corresponding operator to the pixel value of the selected pixel based on the filter guide value for the selected pixel. At least one parameter of the corresponding operator may differ across the plurality of classes as a function of the filter guide value.

In a third example embodiment, a system may include a processor and a non-transitory computer-readable medium having stored thereon instructions that, when executed by the processor, cause the processor to perform operations in accordance with the first example embodiment and/or the second example embodiment.

In a fourth example embodiment, a non-transitory computer-readable medium may have stored thereon instructions that, when executed by a computing device, cause the computing device to perform operations in accordance with the first example embodiment and/or the second example embodiment.

In a fifth example embodiment, a system may include various means for carrying out each of the operations of the first example embodiment and/or the second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing device, in accordance with examples described herein.

FIG. 2 illustrates a computing system, in accordance with examples described herein.

FIG. 3 illustrates an image processing system, in accordance with examples described herein.

FIG. 4 illustrates a grid slicing circuitry, in accordance with examples described herein.

FIG. 5 illustrates example images, in accordance with examples described herein.

FIG. 6 illustrates a training system, in accordance with examples described herein.

FIG. 7 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. OVERVIEW

An image filter may be configured to generate an output image by applying a corresponding operator to an input image. In determining an output value of a given pixel of the output image, the operator may consider an input value of a corresponding pixel in the input image and, in some cases, input values of one or more pixels that neighbor the corresponding pixel in the input image. It may be desirable to vary at least one parameter of the operator based on the image feature that is represented by the input values. That is, it may be desirable to vary at least one parameter of the operator based on semantic information associated with the input values, such that a given input value is filtered differently depending on a classification of the image feature that the given input value forms part of. For example, different amounts of filtering may be applied to a blue pixel, depending on whether the blue pixel forms part of a sky, a body of water, an item of clothing, a vehicle, or an actor's hair, among other possibilities.

Accordingly, the operator may be configured to receive as input one or more pixel values of one or more pixels of the input image and one or more filter guide values corresponding to the one or more pixels of the input image. The filter guide values may be based on semantic information of corresponding pixels of the input image, and may be configured to control a semantic variability of the operator. For example, the filter guide values may attenuate the effects of the operator for some image features and/or amplify the effects of the operator for other image features.

The filter guide values may be determined using transform coefficients configured to map pixel values of the input image to the filter guide values. The transform coefficients may be determined by processing the input image using one or more machine learning (ML) models. In some examples, the transform coefficients may be affine transform coefficients. The ML models may be configured to process a reduced resolution version of the input image (e.g., due to speed, memory, and/or energy considerations), and the transform coefficients may thus be generated at the reduced resolution, rather than at the full resolution of the input image. However, the output image may be generated at the full resolution of the input image, and it may thus be necessary to upsample the transform coefficients to the full resolution.

Accordingly, the transform coefficients may be represented using a bilateral grid that includes a plurality of cells arranged in three dimensions (e.g., width, height, and range). For example, a bilateral grid model that includes the one or more ML models may be configured to determine a segmentation map that divides pixels of the input image among a plurality of semantic classes. The bilateral grid model may be configured to determine a transform coefficient map based on the segmentation map. That is, the semantic class information of each pixel of the segmentation map may be mapped to one or more corresponding transform coefficients that, when applied to a corresponding pixel of the input image, are configured to generate a filter guide value for a corresponding pixel of the input image. The bilateral grid model may be configured to generate the bilateral grid by distributing (i.e., splatting) the transform coefficients of each pixel of the segmentation map among nodes of the bilateral grid. In some implementations, the bilateral grid model may be configured to determine the bilateral grid directly (e.g., using a single ML model) without generating the segmentation map and/or the transform coefficient map as intermediate outputs.

A grid slicer may be configured to determine the transform coefficients for a selected pixel of the input image by slicing the bilateral grid. Specifically, the grid slicer may be configured to upsample and decompress the transform coefficients for the selected pixel by reversing the splatting operation, which may involve interpolating the value of the bilateral grid at coordinates corresponding to the selected pixel. The transform coefficients extracted from the bilateral grid may be applied to a pixel value of the selected pixel by, for example, determining a dot product of the pixel value and the transform coefficients, resulting in the filter guide value for the selected pixel. Thus, the semantic class information of each respective pixel of the input image may be transformed into a filter guide value configured to control an extent of filtering to be applied to the respective pixel, thus allowing semantically varying filtering of the input image.

The pixel value and the filter guide value of the selected pixel may be provided as input to the image filter, which may perform a semantically variable modification of the pixel value in accordance with the filter guide value. The extent of filtering applied across semantic classes may be learned by the bilateral grid model, and may be filter-specific, such that a different bilateral grid of transform coefficients may be generated for each of a plurality of image filters to be applied to the input image. The semantic variability of different filters may be learned by an image processing system that includes, among other components, the bilateral grid model, the grid slicer, and the image filter, based on training samples that include pairs of unfiltered input images and filtered input images that represent the semantically variable modification to be learned.

Representing the transform coefficients using the bilateral grid may allow the image processing system to operate on individual pixels of the input image. That is, because the bilateral grid allows for upsampling of the transform coefficients of individual pixels of the input image, the image processing system may be able to upsample the transform coefficients of pixels that are planned to be modified and avoid upsampling the transform coefficients of pixels that are not planned to be modified. For example, the image processing system may be configured to process a region of the input image, rather than the entirety thereof, based on a manual and/or automated selection of the region. The region may be selected based on, for example, a digital zoom applied to the input image based on user input, and/or based on a size of hardware (e.g., memory and image processing circuitry) configured to process the input image in sections (e.g., in a sequence of columns of the input image).

### II. EXAMPLE COMPUTING DEVICES AND SYSTEMS

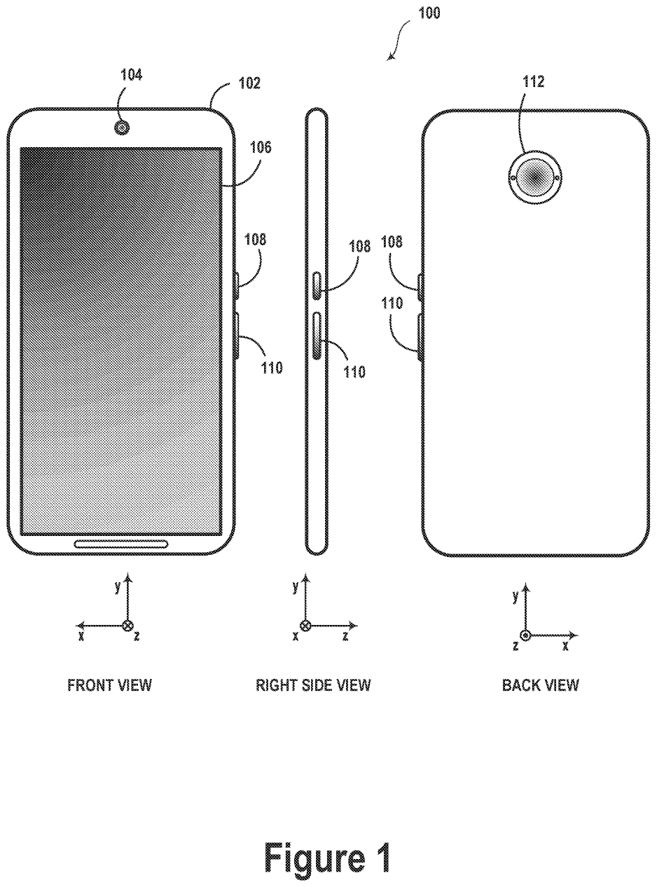

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and rear-facing camera 112.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

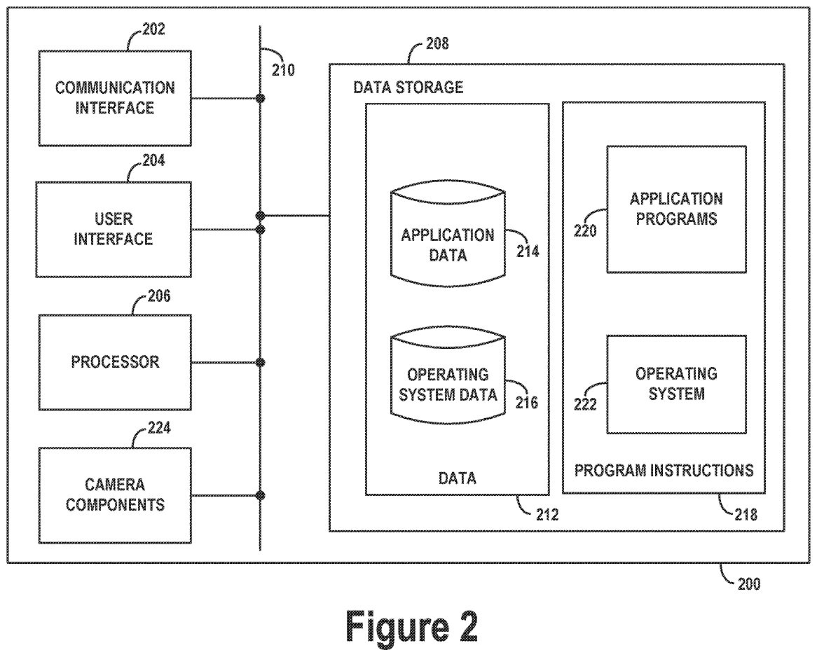

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, application-specific integrated circuits (ASICs), and/or tensor processing units (TPUs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

### III. EXAMPLE IMAGE PROCESSING SYSTEM

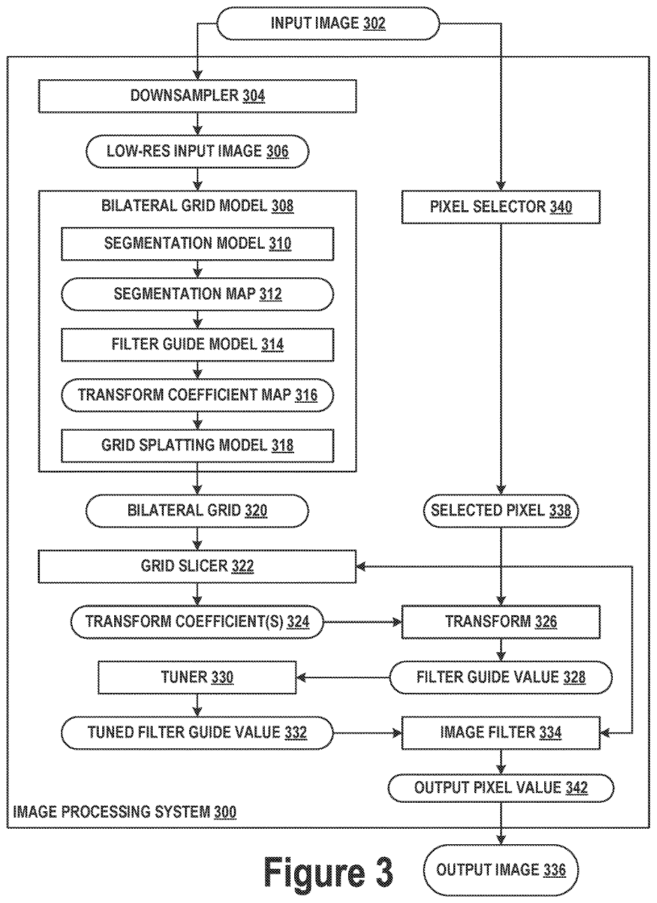

FIG. 3 illustrates an example image processing system 300. Image processing system 300 may be configured to generate output image 336 based on input image 302. Image processing system 300 may form part of an image editing system, a display system, and/or a video encoding/decoding system, among other possibilities. For example, image processing system 300 may be implemented as part of computing device 100 and/or computing system 200. Components of image processing system 300 may be implemented using software (i.e., as instructions executable using a processor) and/or hardware (e.g., as circuitries configured to perform the operations described herein). For example, image processing system 300 may be implemented at least in part using image processing hardware of computing device 100.

Image processing system 300 may include downsampler 304, bilateral grid model 308, pixel selector 340, grid slicer 322, transform 326, tuner 330, and image filter 334. Image filter 334 may be configured to apply a corresponding operator to input image 302 to generate output image 336, and at least one parameter of the operator may vary based on semantic information associated with each pixel of input image 302. That is, image filter 334 may perform a semantically variable modification of input image 302 to generate output image 336.

Downsampler 304 may be configured to generate low-resolution (“low-res”) input image 306 based on input image 302. For example, input image 302 may have a resolution of 4K (e.g., 3840 pixels by 2160 pixels) or 8K (e.g., 7680 pixels by 4320 pixels). Low-res input image 306 may have a resolution that is smaller than a resolution of input image 302. For example, low-res input image 306 may have a resolution of 768 pixels by 432 pixels, 640 pixels by 480 pixels, or 320 pixels by 240 pixels, among other possibilities. Thus, it may be faster and/or more computationally efficient to process, using bilateral grid model 308, low-res input image 306 rather than input image 302. For example, by operating on low-res input image 306, a number of parameters of bilateral grid model 308 may be reduced, and thus an execution time of bilateral grid model 308 may be improved.

Bilateral grid model 308 may be configured to generate bilateral grid 320 based on low-res input image 306. Bilateral grid 320 may represent a plurality of transform coefficients that are configured to map pixel values of input image 302 to corresponding filter guide values. The filter guide values may be used to control the semantic variability of image filter 334. Bilateral grid 320 may provide a compressed representation of the plurality of transform coefficients, and may allow transform coefficients to be determined and applied to individual pixels of input image 302 independently of other neighboring pixels.

Bilateral grid 320 may include a three-dimensional (3D) array of nodes having a spatial resolution (i.e., width and height) that corresponds to a spatial resolution (i.e., width and height) of input image 302 and/or low-res input image 306, and a range resolution that corresponds to a pixel value range of input image 302 and/or low-res input image 306. The spatial resolution and range resolution of bilateral grid 320 may be smaller than the spatial resolution and range resolution, respectively, of input image 302. In some implementations, the spatial resolution and range resolution of bilateral grid 320 may also be smaller than the spatial resolution and range resolution, respectively, of low-res input image 306. Thus, bilateral grid 320 may provide a compressed representation of the information extracted by bilateral grid model 308 from input image 302 and/or low-res input image 306.

Bilateral grid model 308 may include segmentation model 310, filter guide model 314, and grid splatting model 318. Segmentation model 310 may be configured to generate segmentation map 312 based on low-res input image 306. Segmentation model 310 may include a machine learning (ML) model, such as an artificial neural network, configured to perform at least some of the operations thereof. Segmentation map 312 may represent a segmentation of one or more image features belonging to one or more classes. For example, segmentation map 312 may represent a segmentation of a plurality of image features belonging to a plurality of classes. Thus, segmentation map 312 may include, for each respective pixel of low-res input image 306, corresponding one or more values that represent semantic information associated with of an image feature represented by the respective pixel.

Specifically, segmentation map 312 may include, for each respective pixel of low-res input image 306, at least one corresponding segmentation value that indicates a corresponding class of the image feature represented by the respective pixel. In one example, segmentation map 312 may have a dimension of H×W×1, where each of the H×W pixels is associated with a single value indicating the corresponding class thereof. The single value may be, for example, a probability value indicating a likelihood that the image feature belongs to a particular class, or a class value indicating a class of the image feature. In another example, segmentation map 312 may have a dimension of H×W×D, where each of the H×W pixels is associated with D segmentation values corresponding to D possible classes, and where each respective segmentation value of the D segmentation values represents a likelihood of the image feature belonging to the corresponding class.

Filter guide model 314 may be configured to generate transform coefficient map 316 based on segmentation map 312. Filter guide model 314 may include an ML model configured to perform at least some of the operations thereof. Transform coefficient map 316 may include, for each respective pixel of low-res input image 306, at least one corresponding transform coefficient configured to map a pixel value of the respective pixel to a corresponding filter guide value. The corresponding filter guide value may be used by image filter 334 to apply, to pixels of input image 302 that correspond to the respective pixel of low-res input image 306, one or more operators in a semantically varying manner. Thus, filter guide model 314 may be configured to map segmentation values that represent a plurality of different classes of image features to transform coefficients that, when applied to pixels of input image 302 and/or low-res input image 306, generate filter guide values representing spatial variations in an extent of filtering to be performed by image filter 334.

In one example, transform coefficient map 316 may have a dimension of H×W×1, where each of the H×W pixels is associated with at least one transform coefficient value configured to map a grayscale value of a corresponding pixel in low-res input image 306 to a corresponding filter guide value. In another example, transform coefficient map 316 may have a dimension of H×W×3, where each of the H×W pixels is associated with at least three transform coefficient values configured to map three color values (e.g., red-green-blue) of a corresponding pixel in low-res input image 306 to a corresponding filter guide value. In some implementations, transform coefficient map 316 may represent the transform coefficient using homogenous coordinates, and may thus have a dimension of H×W×4 for color images.

Grid splatting model 318 may be configured to generate bilateral grid 320 based on transform coefficient map 316. Bilateral grid 320 may include a plurality of nodes arranged in a 3D array. For example, bilateral grid 320 may be arranged into a 3D array of I nodes, by J nodes, by K nodes, and may thus include I×J×K nodes. For example, bilateral grid may include sizes between 16×12×8 and 64×48×32. That is, I may range from 16 to 64, J may range from 12 to 48, and K may range from 8 to 32, although other values of I, J, and K may also be used.

Prior to processing transform coefficient map 316, grid splatting model 318 may be configured to initialize each respective node of bilateral grid 320 to 0. This operation may be expressed as Γ(i, j, k)=(0,0), where Γ(i, j, k) denotes the value of a respective cell, denoted by indexes i, j, and k, of bilateral grid 320. Grid splatting model 318 may implement the function Γ([x/s_{sc}], [y/s_{sc}], [I(x, y)/s_{rc}])+=(I(x, y), 1), where [⋅] represents a closest-integer operator, I(x, y) represents the transform coefficient at spatial coordinates (x, y) of transform coefficient map 316, s_{sc} represents a spatial sampling rate used for generating bilateral grid 320, and s_{rc} represents a range sampling rate used for generating bilateral grid 320. Thus, each respective node of bilateral grid 320 may be configured to accumulate a range-scaled value of the transform coefficients of zero or more spatially corresponding pixels of transform coefficient map 316 and, in some implementations, a count of a number of pixels accumulated into the respective node. For example, the count of the number of pixels accumulated into the respective node may be expressed as a weight value stored as part of the respective node using homogenous coordinates. The process of generating bilateral grid 320 may be referred to as splatting.

Bilateral grid 320 may provide a compressed representation of transform coefficient map 316 that allows individual pixels of transform coefficient map 316 to be upsampled to a resolution of input image 302 independently of upsampling other (e.g., neighboring) pixels of transform coefficient map 316. Thus, representing transform coefficient map 316 using bilateral grid 320 may allow image filter 334 to apply its operator in a semantically dependent manner to as little as one pixel of input image 302. Accordingly, image filter 334 may be applied to selected parts of input image 302 independently of other, non-selected parts of image 302. A spatial resolution of bilateral grid 320 may be smaller than a spatial resolution of input image 302 and, in some implementations, also smaller than a spatial resolution of low-res input image 306.

In some implementations, the operations of bilateral grid model 308 may be carried out using an alternative arrangement of models and/or algorithms. In one example, bilateral grid model 308 may be implemented using a single ML model (rather than a sequence of multiple separate ML models) configured to generate bilateral grid 320 based on processing low-res input image 306. Such implementations thus might not explicitly generate segmentation map 312 and/or transform coefficient map 316 as intermediate outputs, and may instead generate bilateral grid 320 directly from low-res input image 306. In another example, bilateral grid model 308 may include segmentation model 310 and filter guide model 314, and grid splatting model 318 may also be implemented using an ML model configured to perform the operations thereof. Thus, splatting may be performed using a learned function, rather than a predetermined function.

Pixel selector 340 may be configured to determine selected pixel 338 from input image 302. Selected pixel 338 may represent the respective coordinates and/or pixel value of a particular pixel of input image 302. Selected pixel 338 may be represented at the resolution of input image 302 (rather than at the resolution of low-res input image 306). Different values of selected pixel 338 may allow image processing system 300 to control the part of input image 302 to which image filter 334 is applied.

Pixel selector 340 may be configured to determine selected pixel 338 based on a digital zoom applied to input image 302, a portion of input image 302 selected for filtering based on user input, and/or a portion of input image 302 selected for filtering based on a hardware-specific sequence of image portions. Accordingly, pixel selector 340 may be configured to select a subset of input image 302 to which image filter 334 is to be applied independently of other, non-selected portions of input image 302. For example, image processing system 300 may be implemented as part of image processing hardware that is configured to divide input image 302 into a plurality of columns, a plurality of rows, and/or a plurality of regions of interest (ROI), and process each column, row, and/or ROI independently of the others. Thus, pixel selector 340 may be configured to select pixels of input image 302 according to the hardware-specific sequence of columns, rows, and/or ROIs.

Grid slicer 322 may be configured to generate transform coefficient(s) 324 based on bilateral grid 320 and selected pixel 338. The process of extracting data from bilateral grid 320 may be referred to as slicing. Specifically, grid slicer 322 may be configured to generate transform coefficient(s) 324 by determining the value of bilateral grid 320 at location C=(x/s_{sd}, y/s_{sd}, E(x, y)/s_{rd}) using trilinear interpolation, where E(x, y) represents the pixel value of a reference image at spatial coordinates (x, y), s_{sd} represents a spatial sampling rate used for slicing bilateral grid 320, and s_{rd} represents a range sampling rate used for slicing bilateral grid 320. That is, since bilateral grid 320 stores values at integer-indexed nodes, and location C is not limited to integer values, transform coefficient(s) 324 may be determined by interpolating the values of up to 8 nodes that surround location C. In implementations where each node stores a count of the number of pixel values accumulated therein, the trilinear interpolation may be weighted according to the count. Transform coefficient(s) 324 may thus represent a decompressed version of the transform coefficient(s) associated with selected pixel 338 in transform coefficient map 316.

A number of transform coefficient(s) 324 may be equal to a number of transform coefficient(s) for selected pixel 338 in transform coefficient map 316. For example, when transform coefficient map 316 includes 4 transform coefficients for selected pixel 338, transform coefficient(s) 324 may represent a decompression of these 4 transform coefficients, and may thus also include 4 transform coefficients.

The pixel value E(x, y) of the reference image may be represented by selected pixel 338. In some implementations, the reference image may be input image 302. Thus, the spatial sampling rate se used for splatting may be different from the spatial sampling rate s_{sd} used for slicing. Accordingly, the slicing operation executed based on bilateral grid 320 may have the effect of generating transform coefficient(s) 324 at the spatial resolution of input image 302. In other implementations, the reference image may be an image other than input image 302. For example, the reference image may be low-res input image 306, segmentation map 312, and/or transform coefficient map 316. Thus, the spatial sampling rate se used for splatting may be equal to the spatial sampling rate s_{sd} used for slicing. Accordingly, the slicing operation executed based on bilateral grid 320 may have the effect of generating transform coefficient(s) 324 at the spatial resolution of low-res input image 306, and additional upsampling may be performed (e.g., by tuner 330) to the spatial resolution of input image 302.

Transform 326 may be configured to generate filter guide value 328 based on transform coefficient(s) 324. In one example, transform 326 may represent a dot product between a pixel value of selected pixel 338 and transform coefficient(s) 324. In cases where transform coefficient(s) 324 are represented using homogenous coordinates, the pixel value of selected pixel 338 may also be represented using homogenous coordinates. Transform 326 may thus map pixel values of input image 302, using transform coefficients generated by bilateral grid model 308 and grid slicer 322, to corresponding semantically varying filter guide values. Image processing system 300 may be configured to determine and use filter guide value 328 for individual pixels of input image 302, thus allowing image filter 334 to be applied to individual pixels of input image 302 at the resolution thereof.

In some implementations, tuner 330 may be configured to generate tuned filter guide value 332 based on filter guide value 328. Tuner 330 may include one or more modifiable tuning parameters configured to tune filter guide value 328 without retraining of bilateral grid model 308 and/or components thereof. For example, filter guide value 328 may be associated with a corresponding range of potential values (e.g., 0 to 255, 0 to 1, etc.), and tuner 330 may be configured to amplify filter guide values in a first portion of the range and/or attenuate filter guide values in a second portion of the range. In some implementations, tuner 330 may be omitted, and filter guide value 328 may be used without amplification and/or attenuation by tuner 330. Thus, filter guide value 328 and tuned filter guide value 332 may be used interchangeably.

Image filter 334 may be configured to generate output pixel value 342 based on the pixel value of selected pixel 338 and tuned filter guide value 332. In implementations where tuner 330 is omitted, image filter 334 may utilize filter guide value 328 instead of tuned filter guide value 332. Output image 336 may be formed using a plurality of output pixel values 342 corresponding to the plurality of pixels of input image 302. In cases where image processing system 300 is applied to all pixels of input image 302, output image 336 may have a same number of pixels as input image 302. In cases where image processing system 300 is applied to a proper subset of pixels of input image 302, output image 336 may have a smaller number of pixels than input image 302.

Output pixel value 342 may be expressed as O(x, y)=f(N(x, y), G(x, y)), where (x, y) represent the spatial coordinates of selected pixel 338, N( ) represents the pixel value of a corresponding pixel of input image 302 to be filtered by image filter 334, G( ) represents tuned filter guide value 332 for the corresponding pixel of input image 302, and f( ) represents the operator/function implemented by image filter 334. Thus, the operator/function implemented by image filter 334 may be a function of tuned filter guide value 332. Since tuned filter guide value 332 is based on the semantic content of the corresponding pixel of input image 302, the visual quality of output image 336 (as determined by the extent of filtering applied by image filter 334) varies spatially as a function of the semantic content of different portions of input image 302.

In some implementations, f( ) may additionally be a function of pixel values and/or filter guide values of one or more pixels neighboring selected pixel 338. For example, output pixel value 342 may be expressed as O(x, y)=f(N*(x, y), G*(x, y)), where N*(x, y) represents a plurality of pixel values of a plurality of pixels within a window of a predetermined size centered on selected pixel 338 and G*(x, y) represents a plurality of filter guide values of a plurality of pixels within the window centered on selected pixel 338. In general, f( ) may represent any linear or non-linear mapping of the inputs thereof to output pixel value 342, including sharpening, blurring, denoising, color modification, style modification, contrast modification, white balance modification, and/or combinations thereof.

In some implementations, image processing system 300 may include a plurality of different image filters, each of which may be configured to apply a corresponding operator/function to input image 302. The semantic variability of the plurality of image filters may differ. For example, for a particular semantic feature, it may be desirable to apply a high amount of filtering of a first type, a low amount of filtering of a second type, and a moderate amount of filtering of a third type. Accordingly, for each respective image filter of the plurality of image filters, bilateral grid model 308 may be configured to generate a corresponding instance of bilateral grid 320, which may be used to determine a corresponding filter-specific instance of tuned filter guide value 332 for pixels of input image 302. Thus, each respective image filter of the plurality of image filters may be configured to apply its corresponding operator/function based on a filter-specific semantic variability across different image features.

In some implementations, transform coefficient(s) 324 may include a plurality of sets of transform coefficient(s) each associated with a corresponding parameter of image filter 334. Thus, different parameters of image filter 334 may be modified to different extents based on the semantic information associated with selected pixel 338.

### IV. EXAMPLE GRID SLICER

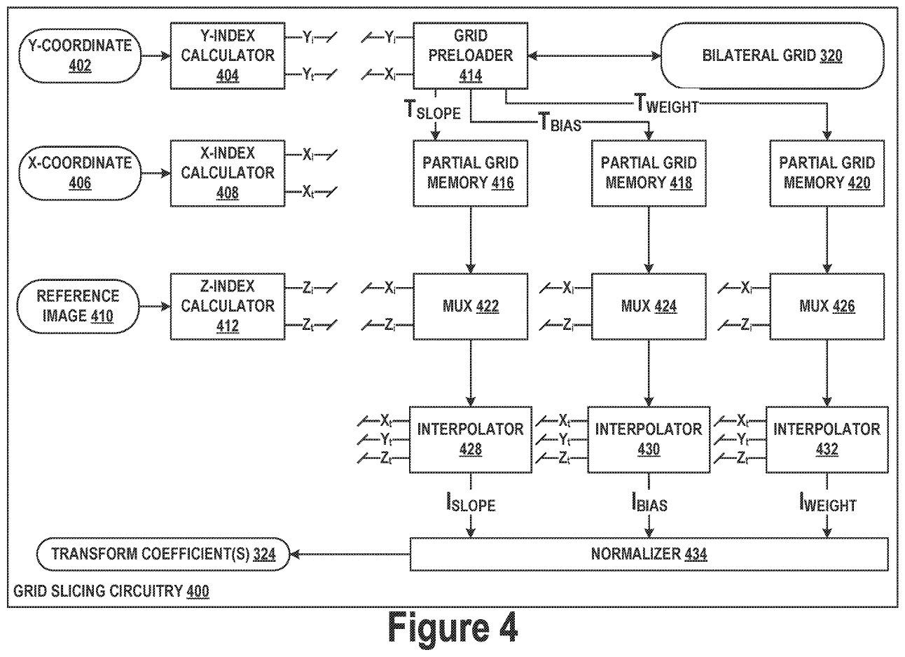

FIG. 4 illustrates an example hardware-based implementation of grid slicer 322. Specifically, grid slicing circuitry 400 may represent circuitry configured to perform the operations of grid slicer 322, including determining transform coefficient(s) 324 for individual pixels of input image 302. Grid slicing circuitry 400 may include y-index calculator 404, x-index calculator 408, z-index calculator 412, grid preloader 414, partial grid memories 416, 418, and 420, multiplexers 422, 424, and 426, and interpolators 428, 430, and 432.

Y-index calculator 404 may be configured to determine y-index Yᵢ and y-index Yₜ based on y-coordinate 402 of selected pixel 338. Yₜ may represent the y-axis position within bilateral grid 320 of selected pixel 338, and may be expressed as Yₜ=y/s_{sd}, where y represents y-coordinate 402. Yᵢ may represent the respective integer-valued y-axis coordinates of cells within bilateral grid 320 that neighbor Yₜ. Yᵢ may be expressed as Y_{i[0]}=Ceiling(Yₜ) and Y_{i[1]}=Floor(Yₜ), where Ceiling( ) determines the smallest integer greater than its input, and Floor( ) determines the largest integer smaller than its input.

X-index calculator 408 may be configured to determine x-index Xᵢ and x-index Xₜ based on x-coordinate 406 of selected pixel 338. Xₜ may represent the x-axis position within bilateral grid 320 of selected pixel 338, and may be expressed as Xₜ=x/s_{sd}, where x represents x-coordinate 406. Xᵢ may represent the respective integer-valued x-axis coordinates of cells within bilateral grid 320 that neighbor Xₜ. Xᵢ may be expressed as X_{i[0]}=Ceiling(Xₜ) and X_{i[1]}=Floor(Xₜ).

Z-index calculator 412 may be configured to determine z-index Zᵢ and z-index Zₜ based on the pixel value of selected pixel 338 in reference image 410 (e.g., input image 302). Zₜ may represent the z-axis position within bilateral grid 320 of selected pixel 338, and may be expressed as Zₜ=E(x, y)/s_{rd}, where E(x, y) represents the pixel value of selected pixel 338. Zᵢ may represent the respective integer-valued z-axis coordinates of cells within bilateral grid 320 that neighbor Zₜ. Zᵢ may be expressed as Z_{i[0]}=Ceiling(Zₜ) and Z_{i[1]}=Floor(Zₜ).

Grid preloader 414 may be configured to load part of bilateral grid 320 based on y-index Yᵢ and x-index Xᵢ. Y-index Yᵢ and x-index Xᵢ may define a plurality of columns of bilateral grid 320, and the values of cells of these columns may be loaded into partial grid memories 416, 418, and 420. Specifically, for each respective preloaded cell of bilateral grid 320, partial grid memory 416 may store one or more first values of the respective preloaded cell, partial grid memory 418 may store one or more second values of the respective preloaded cell, and partial grid memory 420 may store one or more third values of the respective preloaded cell. For example, for each respective preloaded cell, partial grid memory 416 may store the first three values (which may be referred to as slope values T_{SLOPE}) of the respective preloaded cell, partial grid memory 418 may store the fourth value (which may be referred to as bias value T_{BIAs}) of the respective preloaded cell, and partial grid memory 420 may store the fifth value (which may be referred to as weight value T_{WEIGHT}) of the respective preloaded cell.

Portions of bilateral grid 320 that do not correspond to y-coordinate 402 and x-coordinate 406 might not be preloaded into partial grid memories 416, 418, and 420. Accordingly, the size of partial grid memories 416, 418, and 420 may be reduced relative to, for example, memories that would be needed to preload the entirety of bilateral grid 320. Accordingly, the preloading process and the memory retrieval process may utilize fewer memory resources, and may thus be faster due to retrieval and storage of smaller amounts of data. For example, partial grid memories might not preload some parts of bilateral grid 320 that are not expected to be utilized for processing selected pixel 338.

Multiplexers 422, 424, and 426 may be configured to iterate through the values of preloaded cells stored in partial grid memories 416, 418, and 420, respectively, based on x-index Xᵢ and z-index Zᵢ. Specifically, multiplexers 422, 424, and 426 may be configured to provide, to interpolators 428, 430, and 432, respectively, the corresponding values of nodes of bilateral grid 320 to be used in interpolating the value of bilateral grid 320 at coordinate (Xᵢ, Yᵢ, Zᵢ).

Interpolators 428, 430, and 432 may be configured to determine the value of bilateral grid 320 at coordinate (Xᵢ, Yᵢ, Zᵢ) by interpolating the corresponding values of up to 8 integer-indexed grid nodes that surround coordinate (Xᵢ, Yᵢ, Zᵢ). The up to 8 integer-indexed grid cells may include (X_{i[0]}, Y_{i[0]}, Z_{i[0]}), (X_{i[1]}, Y_{i[0]}, Z_{i[0]}), (X_{i[0]}, Y_{i[1]}, Z_{i[0]}), (X_{i[0]}, Y_{i[0]}, Z_{i[1]}), (X_{i[1]}, Y_{i[1]}, Z_{i[0]}), (X_{i[1]}, Y_{i[0]}, Z_{i[1]}), and (X_{i[1]}, Y_{i[1]}, Z_{i[1]}). The up to 8 integer-indexed grid cells may thus define corners of a cube within which coordinate (Xᵢ, Yᵢ, Zᵢ) is located, and the value for coordinate (Xᵢ, Yᵢ, Zᵢ) may be determined using trilinear interpolation of the values associated with the corners of the cube. Interpolator 428 may be configured to determine interpolated slope values I_{SLOPE}, interpolator 430 may be configured to determine interpolated bias values I_{BIAS}, and interpolator 432 may be configured to determine interpolated weight values I_{WEIGHT}.

Normalizer 434 may be configured to determine transform coefficient(s) 324 based on the outputs of interpolators 428, 430, and 432. Specifically, normalizer 434 may be configured to normalize the interpolated slope values I_{SLOPE} by dividing interpolated slope values I_{SLOPE} by the interpolated weight values I_{WEIGHT}, and normalize the interpolated bias value I_{BIAS} by dividing interpolated bias value I_{BIAS} by the interpolated weight values I_{WEIGHT} Thus, normalizer 434 may implement the functions T_{COEFFICIENTS}[0: 2]I_{SLOPE}/I_{WEIGHT} and T_{COEFFICIENTS}[3]I_{BIAS}/I_{WEIGHT}. Normalizing the interpolated slope values I_{SLOPE} and the interpolated bias value I_{BIAS} in this manner may allow grid slicing circuitry 400 to account for differing numbers of pixels accumulated in different cells of bilateral grid 320. In some implementations, partial grid memory 420, multiplexer 426, interpolator 432, and normalizer 434 may be omitted, and transform coefficient(s) 324 may thus be equal to interpolated slope values I_{SLOPE} and the interpolated bias value I_{BIAS} (i.e., functions T_{COEFFICIENTS}[0: 2]I_{SLOPE} and T_{COEFFICIENTS}[3]I_{BIAS}).

### V. EXAMPLE IMAGES

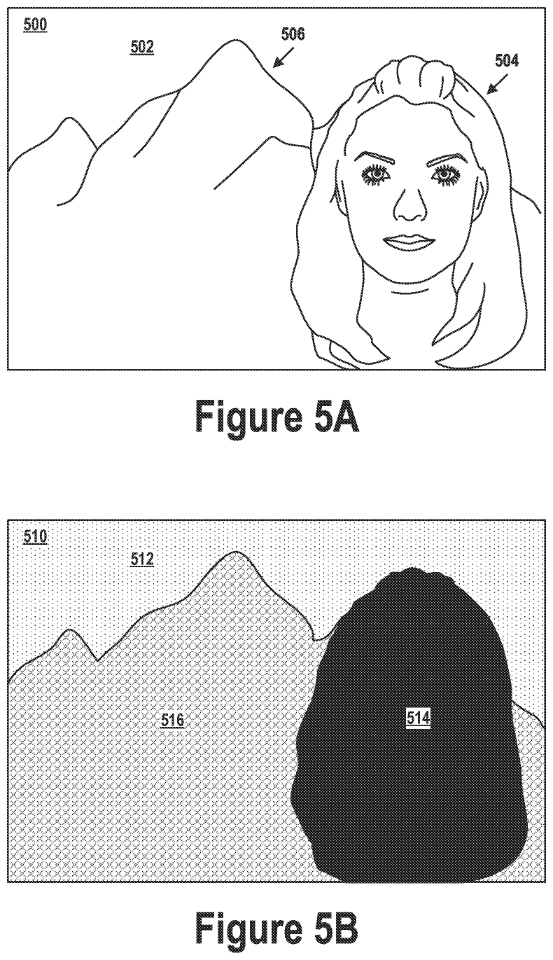

FIG. 5A illustrates an example input image 500 that may be processed by image processing system 300. Input image 500 represents sky 502, mountains 506, and actor 504. Input image 500 may be an example of input image 302. It may be desirable to apply different amounts of filtering to sky 502, mountains 506, and actor 504 to achieve a desired visual effect in a corresponding output image. For example, it may be desirable to apply a high amount of sharpening to sky 502, a moderate amount of sharpening to mountains 506, and a low amount of sharpening to actor 504.

FIG. 5B illustrates an example filter guide image 510 corresponding to input image 500. Filter guide image 510 may represent filter guide value 328 determined by image processing system 300 for each pixel of input image 500. Filter guide image 510 includes region 512, region 514, and region 516, each having a corresponding range of filter guide values. Specifically, region 512 (corresponding to sky 502 in input image 500), includes filter guide values in a first range (e.g., 172 to 255), indicating that a high amount of filtering is to be applied to region 512 by image filter 334. Region 516 (corresponding to mountains 506 in input image 500), includes filter guide values in a second range (e.g., 86 to 171), indicating that a moderate amount of filtering is to be applied to region 516 by image filter 334. Region 514 (corresponding to actor 504 in input image 500), includes filter guide values in a third range (e.g., 0 to 85), indicating that a low amount of filtering is to be applied to region 514 by image filter 334.

### VI. EXAMPLE TRAINING SYSTEM

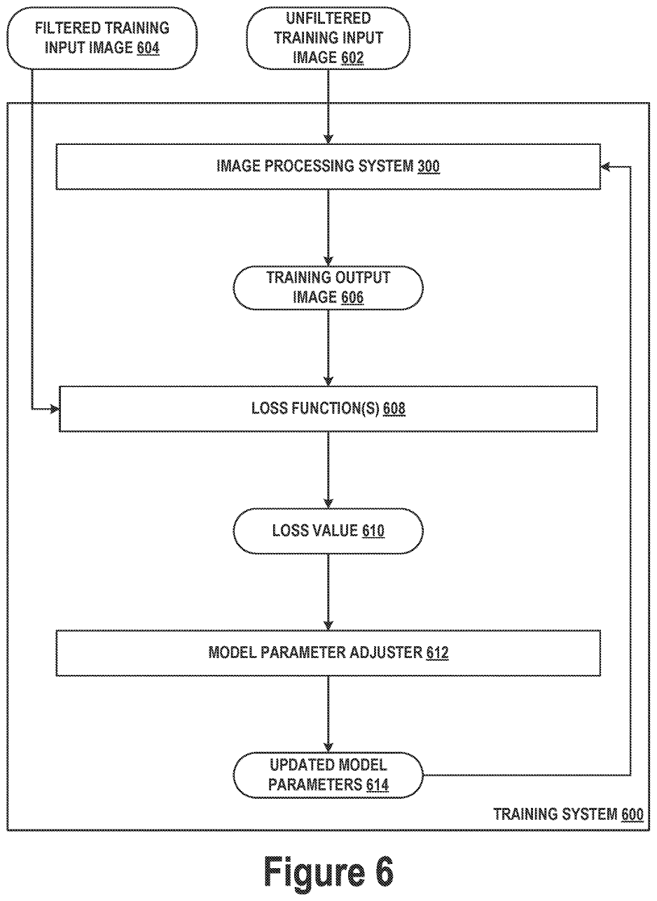

FIG. 6 illustrates training system 600 configured to train one or more trainable components of image processing system 300 based on unfiltered training input image 602 and filtered training input image 604. Specifically, filtered training input image 604 may represent a semantically variable modification of unfiltered training input image 602. Training system 600 may be configured to train image processing system 300 to perform the semantically variable modification.

Training system 600 may include loss function(s) 608 and model parameter adjuster 612. Image processing system 300 may be configured to generate training output image 606 based on unfiltered training input image 602. Unfiltered training image 602 may be analogous to input image 302, and training output image 606 may be analogous to output image 336, but may be processed at training time rather than at inference time.

Loss function(s) 608 may be configured to generate loss value 610 based at least on training output image 606 and filtered training input image 604. For example, loss function(s) 608 may include a mean squared error loss and/or a mean absolute errors loss. Thus, loss function(s) 608 may be configured to incentivize image processing system 300 to generate training output image 606 that matches filtered training input image 604.

In some implementations, loss function(s) 608 may additionally or alternatively include other model-specific loss terms that may be used for training of specific components of image processing system 300. For example, loss function(s) 608 may include a cross entropy loss used for training segmentation model 310. These loss functions may be used for pretraining one or more components of image processing system 300 prior to training image processing system 300 end-to-end based on filtered training input image 604 and unfiltered training input image 602.

Model parameter adjuster 612 may be configured to determine updated model parameters 614 based on loss value 610. Specifically, updated model parameters 614 may be selected such that, during a subsequent iteration of processing of unfiltered training input image 602, training output image 606 more closely matches filtered training input image 604. Updated model parameters 614 may include one or more updated parameters of any trainable component of image processing system 300, including bilateral grid model 308, segmentation model 310, filter guide model 314, and/or grid splatting model 318.

Model parameter adjuster 612 may be configured to determine updated model parameters 614 by, for example, determining a gradient of loss function(s) 608. Based on this gradient and loss value 610, model parameter adjuster 612 may be configured to select updated model parameters 614 that are expected to reduce loss value 610, and thus improve a performance of image processing system 300. After applying updated model parameters 614 to image processing system 300, the operations discussed above may be repeated to compute another instance of loss value 610 and, based thereon, another instance of updated model parameters 614 may be determined and applied to image processing system 300 to further improve the performance thereof. Such training of image processing system 300 may be repeated until, for example, loss value 610 is reduced to below a target loss value.

### VII. ADDITIONAL EXAMPLE OPERATIONS

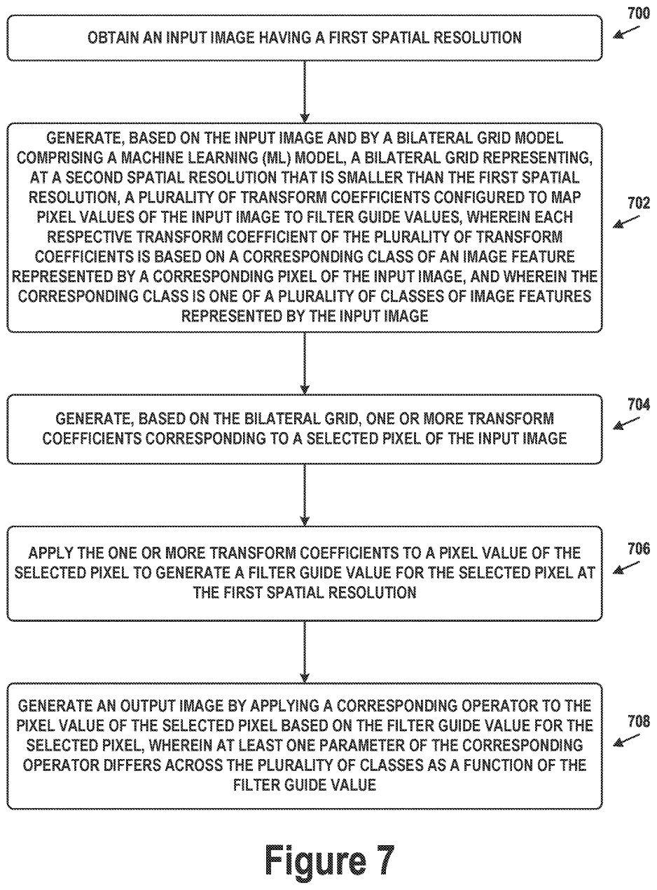

FIG. 7 illustrates a flow chart of operations related to generating an output image by applying a semantically variable image filter to an input image. The operations may be carried out by computing device 100, computing system 200, image processing system 300, and/or training system 600, among other possibilities. The embodiments of FIG. 7 may be simplified by the removal of any one or more of the features shown therein. Further, these embodiments may be combined with features, aspects, and/or implementations of any of the previous figures or otherwise described herein.

Block 700 may involve obtaining an input image having a first spatial resolution. In some examples, the operations of block 700 may be performed by image reception circuitry.

Block 702 may involve generating, based on the input image and by a bilateral grid model that includes an ML model, a bilateral grid representing, at a second spatial resolution that is smaller than the first spatial resolution, a plurality of transform coefficients configured to map pixel values of the input image to filter guide values. Each respective transform coefficient of the plurality of transform coefficients may be based on a corresponding class of an image feature represented by a corresponding pixel of the input image. The corresponding class may be one of a plurality of classes of image features represented by the input image.

Block 704 may involve generating, based on the bilateral grid, one or more transform coefficients corresponding to a selected pixel of the input image. In some examples, the operations of block 704 may be performed by grid slicing circuitry.

Block 706 may involve applying the one or more transform coefficients to a pixel value of the selected pixel to generate a filter guide value for the selected pixel at the first spatial resolution. In some examples, the operations of block 706 may be performed by transform circuitry.

Block 708 may involve generating an output image by applying a corresponding operator to the pixel value of the selected pixel based on the filter guide value for the selected pixel. At least one parameter of the corresponding operator may differ across the plurality of classes as a function of the filter guide value. In some examples, the operations of block 708 may be performed by image filter circuitry.

In some examples, the selected pixel may be determined based on a portion of the input image selected for processing by the image filter circuitry. The grid slicing circuitry and the transform circuitry may each be configured to operate with respect to the selected pixel independently of other pixels of the input image to allow for selective processing of the portion of the input image by the image filter circuitry. In some examples, the selected pixel may be determined by a pixel selection circuitry.

In some examples, the portion of the input image may be selected for filtering based on one or more of (i) a digital zoom applied to the input image or (ii) a predefined sequence of region-based image processing by the image filter circuitry.

In some examples, the ML model may be configured to generate the bilateral grid as an output of processing performed by the ML model based on the input image.

In some examples, the ML model may be configured to generate a transform coefficient map as an output of processing performed by the ML model based on of the input image. The bilateral grid model may include a grid splatting model configured to generate the bilateral grid based on the transform coefficient map.

In some examples, the ML model may include (i) a segmentation model configured to generate one or more segmentation maps that represent segmentations within the input image of a plurality of image features of the plurality of classes and (ii) a filter guide model configured to generate the transform coefficient map based on the one or more segmentation maps.

In some examples, the filter guide model may include, for each respective class of the plurality of classes, a mapping between one or more segmentation map values of the respective class and one or more corresponding filter guide values for the respective class.

In some examples, the mapping may be learned by the filter guide model.

In some examples, the mapping may be a predefined hyperparameter of the filter guide model.

In some examples, the bilateral grid may include a plurality of nodes. Each respective node of the plurality of nodes may provide a compressed representation of corresponding one or more transform coefficients of at least one pixel of the input image that is represented by the respective node.

In some examples, each respective node of the plurality of nodes may be associated with a corresponding weight value that represents a number of pixels of the input image that are represented by the respective node. The one or more transform coefficients may be generated by performing an interpolation based on the corresponding weight values of two or more nodes of the plurality of nodes. The two or more nodes may be associated with the selected pixel of the input image.

In some examples, the one or more transform coefficients may define an affine transformation. The affine transformation may be applied by determining a dot product of the one or more transform coefficients and the pixel value to generate the filter guide value for the selected pixel.

In some examples, the grid slicing circuitry may include a memory configured to store a proper subset of the bilateral grid. The grid slicing circuitry may be configured to load, into the memory thereof, a first proper subset of the bilateral grid prior to generating the one or more transform coefficients based on the proper subset. The first proper subset may correspond to the selected pixel.

In some examples, the output image may be displayed. For example, display circuitry may be configured to facilitate display of the output image.

In some examples, the output image may be stored. For example, memory circuitry may be configured to facilitate storage of the output image.

In some examples, the input image having the first spatial resolution may be generated by down-sampling the input image from a third spatial resolution. An up-sampled filter guide value may be generated for the selected pixel at the third spatial resolution. The output image may be generated at the third spatial resolution by applying the corresponding operator to the pixel value of the selected pixel based on the up-sampled filter guide value for the selected pixel.

In some examples, an image resizing circuitry may be configured to (i) generate the input image having the first spatial resolution by down-sampling the input image from the third spatial resolution and (ii) generate the up-sampled filter guide value for the selected pixel at the third spatial resolution. The image filter circuitry may be configured to generate the output image at the third spatial resolution by applying the corresponding operator to the pixel value of the selected pixel based on the up-sampled filter guide value for the selected pixel.

In some examples, one or more parameters of the image resizing circuitry may be modifiable to control at least part of the generation of the up-sampled filter guide value.

### VIII. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A system comprising:
image reception circuitry configured to obtain an input image having a first spatial resolution;
a bilateral grid model comprising a machine learning (ML) model and configured to generate, based on the input image, a bilateral grid representing, at a second spatial resolution that is smaller than the first spatial resolution, a plurality of transform coefficients configured to map pixel values of the input image to filter guide values, wherein each respective transform coefficient of the plurality of transform coefficients is based on a corresponding class of an image feature represented by a corresponding pixel of the input image, and wherein the corresponding class is one of a plurality of classes of image features represented by the input image;
a grid slicing circuitry configured to generate, based on the bilateral grid, one or more transform coefficients corresponding to a selected pixel of the input image;
a transform circuitry configured to apply the one or more transform coefficients to a pixel value of the selected pixel to generate a filter guide value for the selected pixel at the first spatial resolution; and
image filter circuitry configured to generate an output image by applying a corresponding operator to the pixel value of the selected pixel based on the filter guide value for the selected pixel, wherein at least one parameter of the corresponding operator differs across the plurality of classes as a function of the filter guide value.

2. The system of claim 1, further comprising:
a pixel selection circuitry configured to determine the selected pixel based on a portion of the input image selected for processing by the image filter circuitry, wherein the grid slicing circuitry and the transform circuitry are each configured to operate with respect to the selected pixel independently of other pixels of the input image to allow for selective processing of the portion of the input image by the image filter circuitry.

3. The system of claim 2, wherein the portion of the input image is selected for filtering based on one or more of (i) a digital zoom applied to the input image or (ii) a predefined sequence of region-based image processing by the image filter circuitry.

4. The system of claim 1, wherein the ML model is configured to generate the bilateral grid as an output of processing performed by the ML model based on the input image.

5. The system of claim 1, wherein the ML model is configured to generate a transform coefficient map as an output of processing performed by the ML model based on of the input image, and wherein the bilateral grid model comprises a grid splatting model configured to generate the bilateral grid based on the transform coefficient map.

6. The system of claim 5, wherein the ML model comprises (i) a segmentation model configured to generate one or more segmentation maps that represent segmentations within the input image of a plurality of image features of the plurality of classes and (ii) a filter guide model configured to generate the transform coefficient map based on the one or more segmentation maps.

7. The system of claim 6, wherein the filter guide model comprises, for each respective class of the plurality of classes, a mapping between one or more segmentation map values of the respective class and one or more corresponding filter guide values for the respective class.

8. The system of claim 7, wherein the mapping is learned by the filter guide model.

9. The system of claim 7, wherein the mapping is a predefined hyperparameter of the filter guide model.

10. The system of claim 1, wherein the bilateral grid comprises a plurality of nodes, and wherein each respective node of the plurality of nodes provides a compressed representation of corresponding one or more transform coefficients of at least one pixel of the input image that is represented by the respective node.

11. The system of claim 10, wherein each respective node of the plurality of nodes is associated with a corresponding weight value that represents a number of pixels of the input image that are represented by the respective node, and wherein the grid slicing circuitry is configured to generate the one or more transform coefficients by performing an interpolation based on the corresponding weight values of two or more nodes of the plurality of nodes, wherein the two or more nodes are associated with the selected pixel of the input image.

12. The system of claim 1, wherein the one or more transform coefficients define an affine transformation, and wherein the transform circuitry is configured to apply the affine transformation by determining a dot product of the one or more transform coefficients and the pixel value to generate the filter guide value for the selected pixel.

13. The system of claim 1, wherein the grid slicing circuitry comprises a memory configured to store a proper subset of the bilateral grid, wherein the grid slicing circuitry is configured to load, into the memory thereof, a first proper subset of the bilateral grid prior to generating the one or more transform coefficients based on the proper subset, wherein the first proper subset corresponds to the selected pixel.

14. The system of claim 1, further comprising:
display circuitry configured to facilitate display of the output image.

15. The system of claim 1, further comprising:
memory circuitry configured to facilitate storage of the output image.

16. The system of claim 1, further comprising:
an image resizing circuitry configured to (i) generate the input image having the first spatial resolution by down-sampling the input image from a third spatial resolution and (ii) generate an up-sampled filter guide value for the selected pixel at the third spatial resolution, wherein the image filter circuitry is configured to generate the output image at the third spatial resolution by applying the corresponding operator to the pixel value of the selected pixel based on the up-sampled filter guide value for the selected pixel.

17. The system of claim 16, wherein one or more parameters of the image resizing circuitry are modifiable to control at least part of the generation of the up-sampled filter guide value.

18. (canceled)

19. A non-transitory computer-readable medium having stored thereon instructions that, when executed by a computing device, cause the computing device to perform operations comprising:
obtaining an input image having a first spatial resolution;
generating, based on the input image and by a bilateral grid model comprising a machine learning (ML) model, a bilateral grid representing, at a second spatial resolution that is smaller than the first spatial resolution, a plurality of transform coefficients configured to map pixel values of the input image to filter guide values, wherein each respective transform coefficient of the plurality of transform coefficients is based on a corresponding class of an image feature represented by a corresponding pixel of the input image, and wherein the corresponding class is one of a plurality of classes of image features represented by the input image;
generating, based on the bilateral grid, one or more transform coefficients corresponding to a selected pixel of the input image;
applying the one or more transform coefficients to a pixel value of the selected pixel to generate a filter guide value for the selected pixel at the first spatial resolution; and
generating an output image by applying a corresponding operator to the pixel value of the selected pixel based on the filter guide value for the selected pixel, wherein at least one parameter of the corresponding operator differs across the plurality of classes as a function of the filter guide value.

20. A computer-implemented method comprising:
obtaining an input image having a first spatial resolution;
generating, based on the input image and by a bilateral grid model comprising a machine learning (ML) model, a bilateral grid representing, at a second spatial resolution that is smaller than the first spatial resolution, a plurality of transform coefficients configured to map pixel values of the input image to filter guide values, wherein each respective transform coefficient of the plurality of transform coefficients is based on a corresponding class of an image feature represented by a corresponding pixel of the input image, and wherein the corresponding class is one of a plurality of classes of image features represented by the input image;
generating, based on the bilateral grid, one or more transform coefficients corresponding to a selected pixel of the input image;
applying the one or more transform coefficients to a pixel value of the selected pixel to generate a filter guide value for the selected pixel at the first spatial resolution; and
generating an output image by applying a corresponding operator to the pixel value of the selected pixel based on the filter guide value for the selected pixel, wherein at least one parameter of the corresponding operator differs across the plurality of classes as a function of the filter guide value.

21. The computer-implemented method of claim 20, further comprising:
determining the selected pixel based on a portion of the input image selected for processing, wherein the one or more transform coefficients are each generated and applied with respect to the selected pixel independently of other pixels of the input image to allow for selective processing of the portion of the input image.
